(19) United States
(12) Patent Application Publication
(10) Pub. No.: US 2008/0187363 A1
(43) Pub. Date: Aug. 7, 2008

(54) Toner Cartridge Having Multiple Drives

(75) Inventor: Steven Miller, Pinellas Park, FL (US)

Correspondence Address: SMITH HOPEN, PA, 180 PINE AVENUE NORTH, OLDSMAR, FL, 34677, US

(73) Assignee: CARTRIDGE CORPORATION OF AMERICA, INC., Clearwater, FL (US)

(21) Appl. No.: 11/671,094

(22) Filed: Feb. 5, 2007

(51) Int. Cl. G03G 15/06

(52) U.S. Cl. 399/222

(57) ABSTRACT

Provided is a toner cartridge equipped with multiple drives adapted to engage the printer-drive mechanisms of multiple printers. Each drive is associated with at least one of the cartridge-drive structures found on most toner cartridges. Each drive can be associated with one or more cartridge-drive structures such as the toner adder roller gear, toner developer roller gear, toner agitator gear, idler gear and toner sifter gear. Moreover, each drive is adapted to prevent interference with the other drive. This is accomplished in numerous ways, including making each drive removeable or by making the engaging structures on the drives displaceable.

### BACKGROUND OF THE INVENTION

The present invention relates to a toner cartridge adapted to fit within a toner cartridge-receiving cavity of a printer.

Laser printers use a coherent beam of light, hence the term “laser printer,” to expose discrete portions of an image transfer drum thus attracting the printing toner. Toner is a mixture of pigment (most commonly black) and plastic particles. The toner becomes electro-statically attracted to exposed portions of the image transfer drum. The toner is transferred to paper, or other medium, as it passes over the rotating image transfer drum. Subsequently, the paper is heated so that the plastic is melted thereby permanently affixing the ink to the paper.

The vast majority of commercially available desktop laser printers include replaceable or removeable toner cartridges that incorporate an image transfer drum, a toner tank, and a metering system. A drive mechanism is connected to the drum and metering system. Modern toner cartridges often include a variety of sensors that interact with the laser printer to indicate the status of the cartridge. Indications relating to toner level, print quality and general cartridge function are often included as well. A large number of types and sizes of toner cartridges are currently available. The sensing system typically includes an encoder wheel interconnected with a rotating agitating paddle within a cylindrical toner tank. Movement of the agitating paddle feeds toner into the metering system. The encoder wheel reports the movement of the agitating paddle wheel through the toner reservoir.

Printer manufacturers such as IBM, Lexmark, and the like also make the toner cartridges that fit their respective printers. To increase sales of their own toner cartridges, printer manufacturers have added structural features to the printers and to the toner cartridges which serve to prevent use of a competitor's toner cartridge in the printer. Such structural features include the arrangement of the driving mechanism within the printer, as well as on the toner cartridge, that operates the printer. The cartridge will not function if the drive mechanism within the printer does not properly engage the corresponding mechanism on the cartridge.

Thus there is a need for a cartridge having a drive mechanism that enables a single toner cartridge to be used with printers made by differing manufacturers and with differing printers models made by a common manufacturer. However, in view of the prior art considered as a whole at the time the present invention was made, it was not obvious to those of ordinary skill in the pertinent art how the identified need could be fulfilled.

### SUMMARY OF INVENTION

The long-standing but heretofore unfulfilled need for a toner cartridge that enables a single toner cartridge to be used with printers made by differing manufacturers and with differing printers models made by a common manufacturer, and which also includes other improvements that overcome the limitations of prior art toner cartridges is now met by a new, useful, and non-obvious invention.

In a first embodiment, the invention includes a toner cartridge equipped with a plurality of cartridge-drive structures, such as gears, adapted to cause rotation with at least one component inside the cartridge. A plurality of drives (most commonly two, but more are possible) is adapted to engage the printer-drive mechanisms of multiple printers. Each drive is associated with at least one of said cartridge-drive structures. The association need only be sufficient such that rotation of the drive causes rotation of the associated cartridge-drive structure, the drive need not be attached to the associated cartridge-drive structure. It is possible, however, that the drive is coaxially arranged with at least one cartridge-drive structure on a side of the toner cartridge. In varying embodiments the plurality of drives is associated with a cartridge-drive structure selected from the toner adder roller gear, toner developer roller gear, toner agitator gear, idler gear and toner sifter gear.

Given that, commonly, only one drive will be operable at a time; each of the plurality of drives are adapted to prevent interference by the inoperable drive with the operable drive. In one embodiment, at least one of the plurality of drives is removeable. In varying embodiments, each drive comprises at least one engaging structure which directly engages the printer-drive mechanism. In one embodiment, at least one engaging structure is integrally formed with at least one of the plurality of drives.

Various methods are provided for ensuring the inoperable drive does not interfere with operation of the cartridge. For example, in one embodiment at least one engaging structure is displaced when the cartridge is inserted in printers that do not use a printer-drive mechanism in that location. In this embodiment it is preferable that the engaging structure is formed of a material having sufficient rigidity to engage the printer-drive mechanism yet is sufficiently pliable to be displaced when an interfering structure is contacted.

### BRIEF DESCRIPTION OF THE DRAWINGS

For a fuller understanding of the nature and objects of the invention, reference should be made to the following detailed description, taken in connection with the accompanying drawings, in which:

FIG. 1 is a view of the gear train representative of toner cartridges of the prior art (single drive).

FIG. 2A is an isometric view of the present invention showing a toner cartridge having a plurality of drives associated with the gear train.

FIG. 2B is a close-up of the gear train shown in FIG. 2A.

FIG. 3 is a lower-perspective view of the novel toner cartridge.

FIG. 4A is a perspective view of an illustrative drive for use with the invention.

FIG. 4B is a perspective view of an illustrative drive for use with the invention.

FIG. 5A is a perspective view of an illustrative drive for use with the invention.

FIG. 5B is a perspective view of an illustrative drive for use with the invention.

FIG. 6A is a perspective view of an illustrative drive for use with the invention.

FIG. 6B is a perspective view of an illustrative drive for use with the invention.

FIG. 6C is a perspective view of an illustrative drive for use with the invention.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

All toner cartridges communicate with a photoconductive drum on which an electrostatic image is formed. The photoconductive drum rotates in a plane perpendicular to that of the print medium passing through the toner cartridge. A recovery blade is placed in direct contact with the photoconductive drum to capture unused toner. During the imaging stage, the photoconductive drum is exposed to light, usually a laser, which imprints a latent image thereon. A developing roller converts the electrostatic-image into a toner-image. Toner is then transferred to the print medium by means of static electricity, by an opposite polar charge on the print medium, established by a transfer roller.

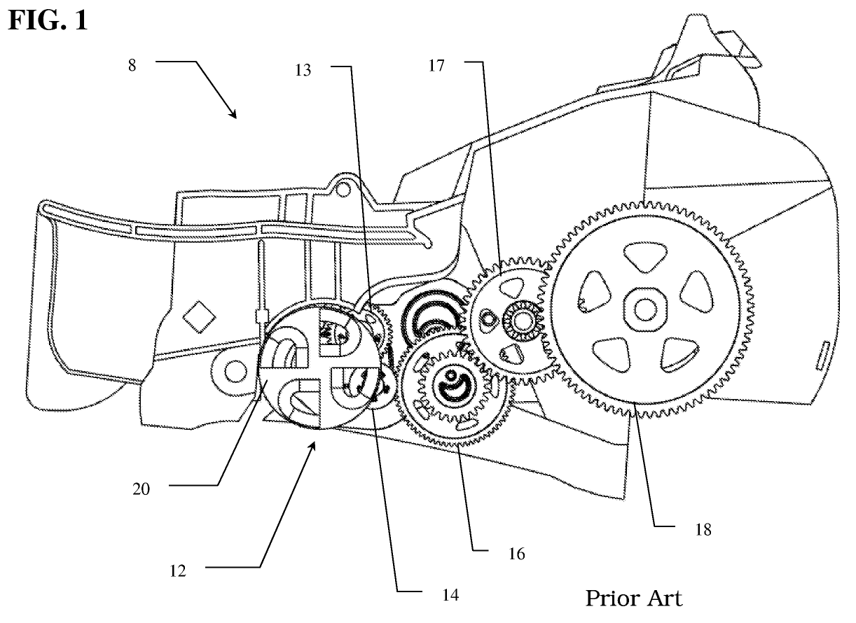

The driving force behind the operation of the toner cartridge derives from a series of gears located on the side of toner cartridge 8 (prior art), see FIG. 1. Drive 20 receives rotational force from a drive means located within the printer. In most cases, the interoperating drive is integrally formed with developer roller gear 12. As it turns, drive 20 transfers the rotational force to idler gear 13 and toner adder roller gear 14. In one example, toner cartridge 10 is equipped with a toner sifter connected to sifter gear 16 which is turned in rotating contact with compound idler gear 17. Lastly, compound idler gear 17 provides the necessary rotational force to agitator gear 18. This arrangement is illustrative of the drive-side arrangement of toner cartridges and this particular arrangement is not necessary for operation of the invention as disclosed. Rather, the present invention can be used with any arrangement which uses more than one cartridge-drive mechanism. Moreover, the term “cartridge-drive” mechanism is not limited to gears, as shown in FIG. 1, but includes any structure adapted to cause rotation of one or more elements within the toner cartridge, including but not limited to belts, chains, and the shaft/axle on which the cartridge element rotates.

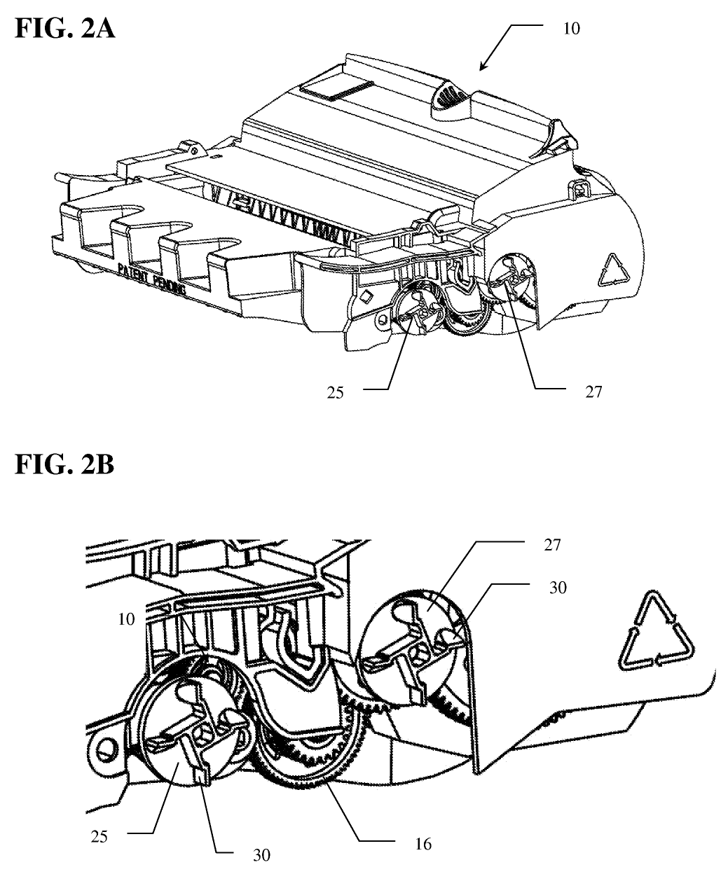

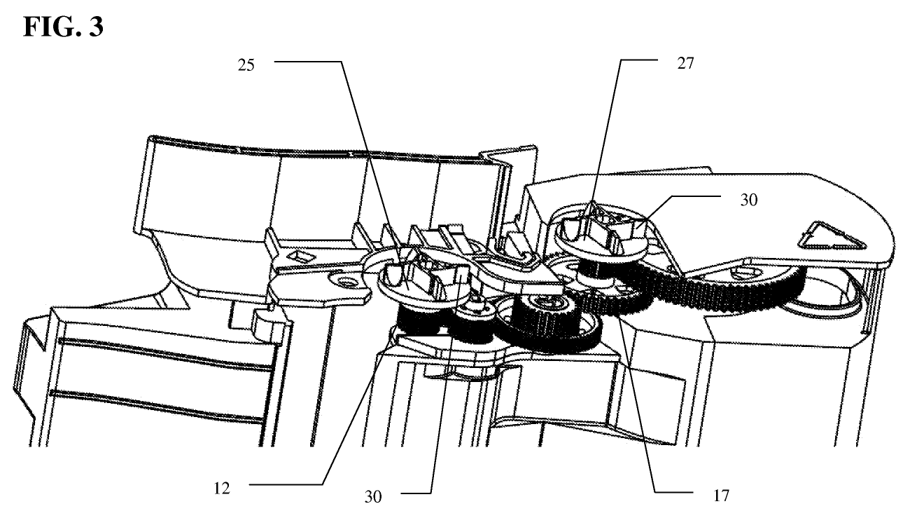

Referring now to FIGS. 2A and B and FIG. 3, cartridge 10 comprises a waste bin, hopper and a cartridge-drive train as described above. Many of these elements are common in toner cartridges. The invention, as shown in FIGS. 2A and B and FIG. 3, further comprises primary drive 25 and secondary drive 27. Primary drive 25 is positioned to engage the printer-drive mechanism of printers belonging to a first class of printers and secondary drive 27 is positioned to engage the printer drive mechanism of printers belonging to a second class of printers. As shown, primary drive 25 is associated with developer roller gear 12 (FIG. 1) and secondary drive 27 is associated with compound idler gear 17 (FIG. 1). It is not necessary, however, to associate either drive with an existing gear. Either, or both drives, can be placed anywhere on the cartridge which will allow the rotational force exerted by the printer-drive mechanism to be transferred to the gear train.

It should be noted that the terms “primary” and “secondary” are arbitrary and do not denote the preference of one drive over the other, nor the order of operation. It should be further noted that the term “a class of printers” refers to all printers whose printer-drive mechanisms would operate a toner cartridge having a single drive. A plurality of printers can be in “a first class of printers” or “a second class of printers” regardless of their manufacturer, family or model. Therefore, all printers whose drive mechanisms would engage the drive mechanism of a cartridge in a first position are said to be in a “first class of printers,” whereas printers whose drive mechanisms would engage the drive mechanism of a cartridge in a second position are said to be in a “second class of printers.”

Both primary drive 25 and secondary drive 27 are adapted to avoid interference with printer operation when the other drive is in use (engaged by the drive mechanism of the printer). That is to say that when the cartridge is inserted in a printer in the first class of printers, thereby engaging primary drive 25, that secondary drive 27 does not interfere with normal operation of the cartridge and vice versa.

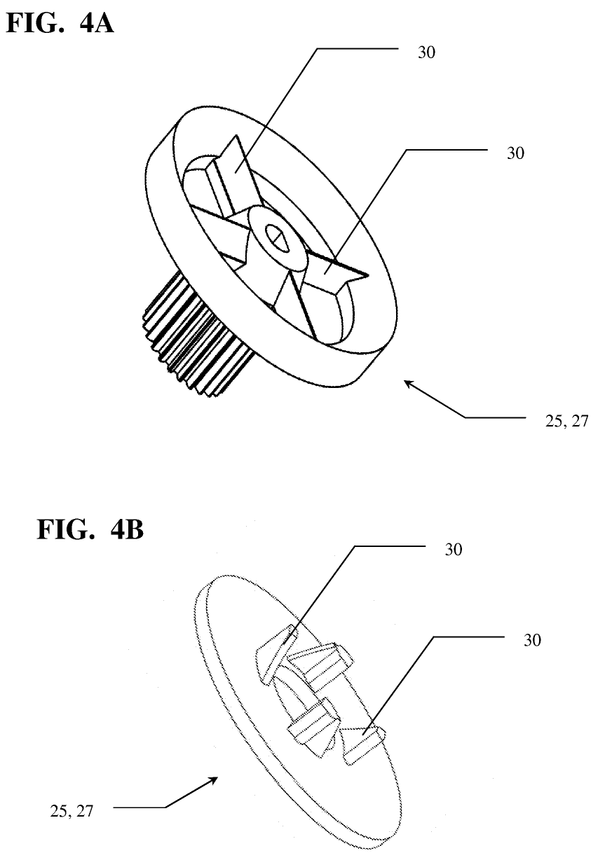

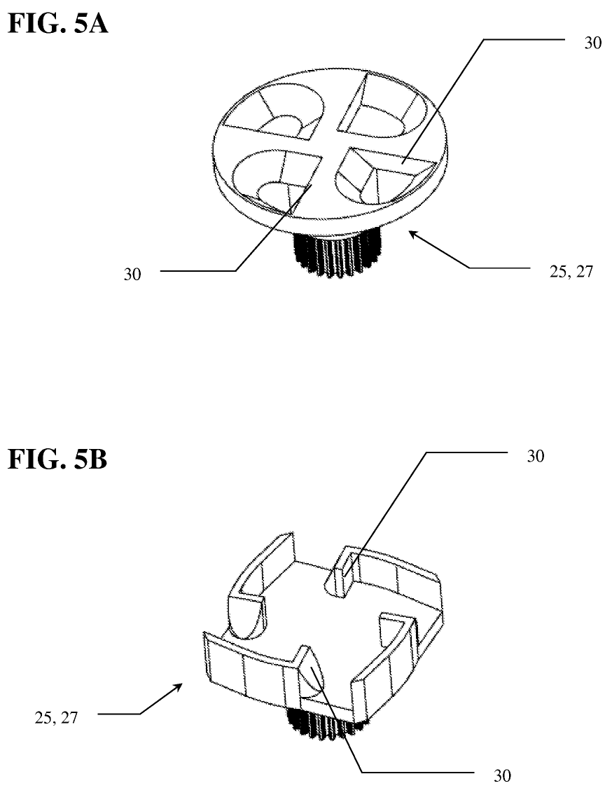

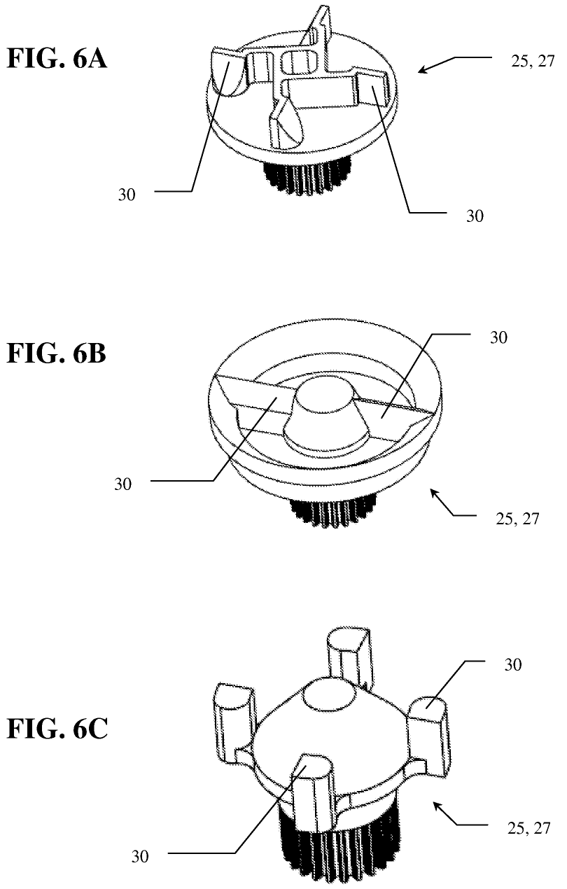

In alternate embodiments, it is possible that primary drive 25 and secondary drive 27 are removeably attached to cartridge 10. In this manner, it is possible to remove a drive that does not have operability in the desired printer to ensure that the unused drive does not interfere with operation of the operable drive. Either drive can be adapted to be permanently, or temporarily, removed. Other means of ensuring the non-operative drive does not interfere with the operative drive include, but are not limited to, making the drives collapsible, expandable, or retractable in order to avoid obstructions as discussed below. In one embodiment, one or both drives are equipped with at least one engaging structure 30, as shown in FIGS. 2 through 6. Engaging structure 30 engages the printer-drive mechanism. Illustrative configurations of engaging structures are shown in FIGS. 4 through 6. The engaging structure can be any structure that will allow coupling of the printer drive to the cartridge drive.

In one embodiment of the novel toner cartridge, engaging structure 30 is positioned to engage the printer-drive mechanism when the cartridge is inserted in a printer. Either engaging structure 30, or the entire drive 25, 27 are displaced, however, when the cartridge is inserted in printers that do not use a printer-drive mechanism in a corresponding location. Accordingly, the toner cartridge is functional in a plurality of printers.

In the embodiments shown in FIGS. 4 through 6, the engaging structure is an arm formed on the surface of drive 25. Engaging structure 30 can be mounted in any manner that corresponds to the printer-drive mechanism in the printer, and is not limited to the illustrative embodiment shown herein. Engaging structure 30 is capable of being displaced from, and returning to, its original position.

When the cartridge is installed in a printer without a corresponding printer-drive mechanism, the interior of the printer-receiving cavity (or a structure therein) contacts engaging structure 30, or the drive 25, 27, thereby causing it to deflect from its original position. The end result in this embodiment is that the engaging structure, or the entire drive, does not interfere with the insertion and operation of the cartridge within the printer-receiving cavity. If the drive or engaging structure were not collapsible, it might be an obstruction in printers that do not use drive mechanisms in that location. It is also possible that the engaging structure is displaced within a cavity in the drive. As previously mentioned, the entire drive can also be displaced upon contact with a non-drive structure within the printer cavity.

In an alternate embodiment, the drive is removeable. The removable drive can be formed as part of the cartridge such that it can be “snapped off” when the cartridge is to be used in a printer without a corresponding printer-drive mechanism. In a preferred embodiment, however, the drive can be removed and then re-attached, “snapped back,” onto the cartridge as conditions and intended use of the cartridge dictate.

A variation of this embodiment allows the altering of a previously constructed cartridge to work in the same manner as the embodiments discussed above. In this embodiment, a pre-existing cartridge is equipped with an additional drive. The drive can be adapted to correspond to any of the gears already present on the drive-side of the cartridge. Examples include, but are not limited to, the toner adder roller gear, toner developer roller gear, toner agitator gear and toner sifter gear.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A toner cartridge adapted to fit in the toner cartridge receiving cavity of a printer, comprising;
a plurality of cartridge-drive structures adapted to cause rotation of at least one component inside the cartridge;
a plurality of drives adapted to engage the printer-drive mechanisms of a plurality of printers, associated with at least one of said cartridge-drive structures.

2. The toner cartridge of claim 1 wherein the plurality of drives is adapted to prevent interference by the inoperable drive with the operable drive.

3. The toner cartridge of claim 1 wherein at least one of the plurality of drives is removeable.

4. The toner cartridge of claim 1 further comprising at least one engaging structure on at least one of the plurality of drives.

5. The toner cartridge of claim 4 wherein at least one engaging structure is integrally formed with at least one of the plurality of drives.

6. The toner cartridge of claim 4 wherein at least one engaging structure is displaced when the cartridge is inserted in printers that do not use a printer-drive mechanism in that location.

7. The toner cartridge of claim 5 wherein at least one engaging structure is formed of a material having sufficient rigidity to engage the printer-drive mechanism.

8. The toner cartridge of claim 1 wherein at least one of the plurality of drives is coaxially arranged with at least one cartridge-drive structure on the drive side of the toner cartridge.

9. The toner cartridge of claim 1 wherein at least one of the plurality of drives is associated with a cartridge-drive structure selected from the toner adder roller gear, toner developer roller gear, toner agitator gear, idler gear and toner sifter gear.

10. A toner cartridge adapted to fit in the toner cartridge receiving cavity of a printer, comprising;
a plurality of cartridge-drive structures adapted to cause rotation of at least one component inside the cartridge;
a primary drive associated with at least one of the plurality of cartridge-drive structures, said primary drive adapted to engage the printer-drive mechanisms of printers belonging to a first family of printers, and
a secondary drive associated with at least one of the plurality of cartridge-drive structures, said secondary drive adapted to engage the printer-drive mechanisms of printers belonging to a second family of printers.

11. The toner cartridge of claim 10 wherein the primary drive is adapted to prevent interference with the secondary drive when the cartridge is in use.

12. The toner cartridge of claim 10 wherein the secondary drive is adapted to prevent interference with the primary drive when the cartridge is in use.

13. The toner cartridge of claim 10 wherein the primary drive is removeable.

14. The toner cartridge of claim 10 wherein the secondary drive is removeable.

15. The toner cartridge of claim 10 further comprising at least one engaging structure on at least one drive selected from the group consisting of the primary drive and the secondary drive.

16. The toner cartridge of claim 15 wherein at least one engaging structure is integrally formed with at least one drive selected from the group consisting of the primary drive and the secondary drive.

17. The toner cartridge of claim 15 wherein at least one engaging structure is displaced when the cartridge is inserted in printers that do not use a printer-drive mechanism in that location.

18. The toner cartridge of claim 15 wherein at least one engaging structure is formed of a material having sufficient rigidity to engage the printer-drive mechanism.

19. The toner cartridge of claim 10 wherein at least one drive selected from the group consisting of the primary drive and the secondary drive is coaxially arranged with at least one cartridge-drive structure on the drive side of the toner cartridge.

20. The toner cartridge of claim 10 wherein at least one drive selected from the group consisting of the primary drive and the secondary drive is associated with a cartridge-drive structure selected from the group consisting of the toner adder roller gear, toner developer roller gear, toner agitator gear, idler gear and toner sifter gear.
